(19) United States
(12) Patent Application Publication
(10) Pub. No.: US 2026/0161400 A1
(43) Pub. Date: Jun. 11, 2026

(54) DEVICE, METHOD AND SYSTEM FOR FILTERING PREFETCHES BASED ON A RECORD OF AN ACCESS HISTORY

(71) Applicant: Intel Corporation, Santa Clara, CA (US)

(72) Inventors: Seth Pugsley, Salt Lake City, UT (US); Douglas Reed, Austin, TX (US)

(73) Assignee: Intel Corporation, Santa Clara, CA (US)

(21) Appl. No.: 18/970,717

(22) Filed: Dec. 5, 2024

(51) Int. Cl. G06F 9/30; G06F 9/48

(52) U.S. Cl. CPC G06F 9/30047; G06F 9/30029; G06F 9/4881

(57) ABSTRACT

Techniques and mechanisms for filtering prefetches based on previous accesses to a memory region. In an embodiment, access history information comprises a record which corresponds to lines of a cache or other suitable memory region. The record identifies, for each such line, whether it has previously been targeted by a respective demand memory access or by a respective prefetch access. A filter is determined based on the record, and an evaluation is performed to identify any of the lines which qualify as a candidate for potential targeting by a future prefetch access. A generation of one or more prefetch requests is performed based on an application of the filter to a vector which indicates the identified candidates. In another embodiment, the vector is a consolidated candidate vector generated based on multiple preliminary candidate vectors, which each correspond to a different respective candidacy detection algorithm.

### BACKGROUND

### 1. Technical Field

This disclosure generally relates to processor operations and more particularly, but not exclusively, to a selective enablement of a prefetch filter based on previous accesses to a corresponding memory region.

### 2. Background Art

Multiprocessor systems are becoming more and more common. Applications of multiprocessor systems include dynamic domain partitioning all the way down to desktop computing. In order to take advantage of some multiprocessor systems, code of a thread to be executed is separated by schedulers to various processing entities for out-of-order execution. Out-of-order execution executes instructions as input to such instructions is made available. Thus, an instruction that appears later in a code sequence is subject to being executed before an instruction appearing earlier in the code sequence.

Some modern computer processors include functionality to speculatively prefetch data during execution. For example, such a processor facilitates execution of a software program by prefetching data to be processed by the program, such as text or video information. The processor prefetches such data in an attempt to reduce the overall execution time of the software program.

As successive generations of processors continue to increase in number, variety, and capability, there is expected to be an increasing premium placed on improvements to efficient provisioning of data in support of program execution.

### BRIEF DESCRIPTION OF THE DRAWINGS

The various embodiments of the present invention are illustrated by way of example, and not by way of limitation, in the figures of the accompanying drawings and in which:

FIG. 1 shows a block diagram illustrating features of a system 100 to filter redundant prefetch candidates according to an embodiment.

FIG. 2 shows a flow diagram illustrating features of a method to apply a prefetch filter based on a history of previous demand memory accesses and previous prefetches according to an embodiment.

FIG. 3 shows a block diagram illustrating features of a processor 300 to apply a filter to a vector which represents consolidated prefetch candidates according to an embodiment.

FIG. 4A shows a flow diagram illustrating features of a method to maintain a record of an access history to facilitate prefetch filtering according to an embodiment.

FIG. 4B shows a flow diagram illustrating features of a method to consolidate prefetch candidates which are identified each according to a respective algorithm according to an embodiment.

FIG. 4C shows a flow diagram illustrating features of a method to selectively filter prefetch candidates based on a history of previous demand memory accesses and previous prefetches according to an embodiment.

FIG. 5 shows a format diagram illustrating features of a processing 500 to apply a filter to prefetch candidates according to an embodiment.

FIG. 6 illustrates an exemplary system.

FIG. 7 illustrates a block diagram of an example processor that may have more than one core and an integrated memory controller.

FIG. 8A is a block diagram illustrating both an exemplary in-order pipeline and an exemplary register renaming, out-of-order issue/execution pipeline according to examples.

FIG. 8B is a block diagram illustrating both an exemplary example of an in-order architecture core and an exemplary register renaming, out-of-order issue/execution architecture core to be included in a processor according to examples.

FIG. 9 illustrates examples of execution unit(s) circuitry.

FIG. 10 is a block diagram of a register architecture according to some examples.

### DETAILED DESCRIPTION

Embodiments discussed herein variously provide techniques and mechanisms for selectively enabling a prefetch filter based on previous accesses to a corresponding memory region. The description herein includes numerous details to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” '7 second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some embodiments variously facilitate the (re) configurability of one or more prefetch functionalities which, for example, each correspond to a different respective set of memory resources. For example, a configuration state of a prefetch filter comprises an enablement state of said filter, wherein the enablement state, at a given time, is one of an enabled state or a disabled state. In various embodiments, enabling a given prefetch filter comprises, or otherwise corresponds to, disabling or otherwise limiting a prefetch functionality which corresponds to said filter. Similarly, disabling said prefetch filter comprises, or otherwise corresponds to, enabling the corresponding prefetch functionality.

As used herein, “demand memory access” refers to a type of access to a given memory location which takes place as part of the execution of a program instruction which is explicitly to read (e.g., load) information from, or write (e.g., store) information to, said memory location. By contrast, “prefetch access” refers herein to another type of access to a given memory location which takes place which takes place in the absence of any program instruction which is explicitly to read information from, or write information to, said memory location.

As used herein, “address space” refers to a set of addresses which are to directly or indirectly identify respective memory locations each in a respective resource of one or more memory resources of a given device or system. A given portion (or “slice”) of such an address space comprises, for example, only a sub-set of all such addresses, wherein the respective addresses in a given slice are for memory locations each in the same one memory region (e.g., the same page of a cache or other memory).

In various embodiments, multiple slices of an address space each correspond to a different respective page or other suitable memory region. In some cases, a given slice comprises multiple addresses which, for example, are numerically contiguous with each other (although some embodiments are not limited in this regard). Additionally or alternatively, each location in a contiguous memory region corresponds to a respective address in the same slice (although some embodiments are not limited in this regard).

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including a processor which supports prefetch filter functionality

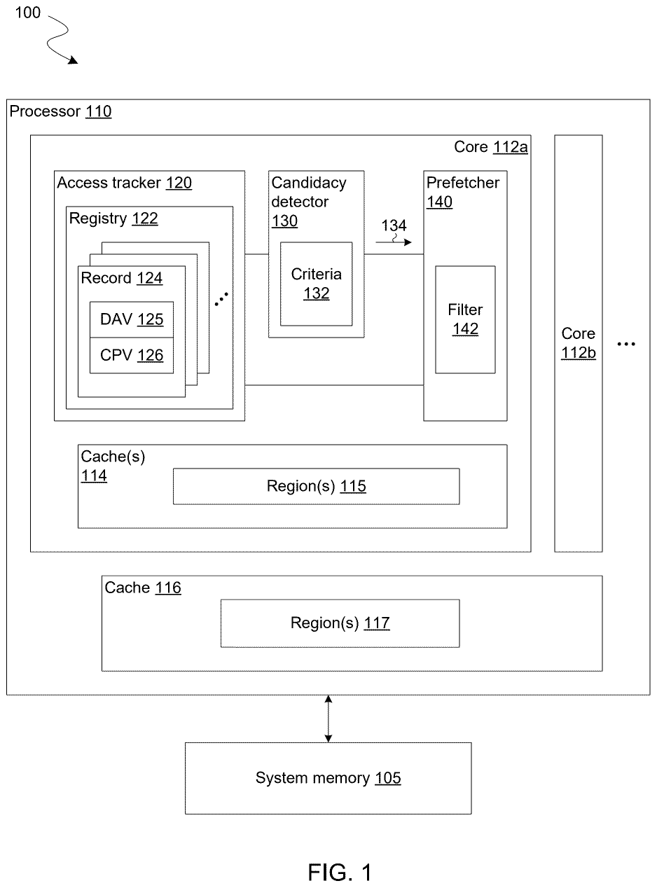

FIG. 1 shows a system 100 which filters redundant prefetch candidates according to an embodiment. System 100 illustrates features of one example embodiment wherein identified opportunities (“prefetch candidates” herein) to perform respective prefetches are evaluated to determine which, if any, potential prefetches are to be filtered. In an embodiment, such evaluation is based on a history of previous demand memory accesses to a given memory region, and of previous completed prefetch accesses to that same given memory region.

In some embodiments, system 100 is all or a portion of an electronic device or component. For example, system 100 is (or otherwise comprises) a cellular telephone, a computer, a server, a network device, a system on a chip (SoC), a controller, a wireless transceiver, a power supply unit, or the like. Furthermore, in some embodiments, system 100 is any of various suitable groupings of related or interconnected devices, such as a datacenter, a computing cluster, etc.

As shown in FIG. 1, system 100 comprises a processor 110 and a system memory 105 which is operatively coupled thereto. Although not shown in FIG. 1, system 100 includes additional components, in some embodiments. In one or more embodiments, system memory 105 is implemented with any of various suitable type(s) of computer memory (e.g., dynamic random access memory (DRAM), static random-access memory (SRAM), non-volatile memory (NVM), a combination of DRAM and NVM, etc.).

Processor 110 is any of various suitable general purpose hardware processors (e.g., a central processing unit (CPU)) or special purpose hardware processors, for example. As shown, processor 110 includes any number of one or more processing cores 112 (e.g., including the illustrative cores 112a, 112b shown). A given one such core 112 facilitates functionality of a central processing unit, graphics processing unit, or the like—e.g., wherein said core 112 includes circuitry adapted from any of various conventional core architectures. For example, core 112a comprises any of a variety of suitable execution units (not shown)—e.g., including one or more arithmetic logic units (ALUs), one or more load pipelines, one or more store pipelines, and/or the like-circuitry of which is to perform algorithms for executing micro-operations and/or other such instructions, in accordance with the embodiment described herein.

In the example embodiment shown, processor 110 includes one or more caches to cache instructions and/or data. By way of illustration and not limitation, core 112a comprises one or more caches 114 which include, but are not limited to, some or all of a level one (L1) cache, and a level two (L2) cache. Alternatively or in addition, a cache 116 is shared by multiple ones of cores 112—e.g., wherein cache 116 is a last level cache (LLC) in a cache hierarchy of processor 110. Some embodiments are not limited to a particular number or configuration of the one or more caches of processor 110.

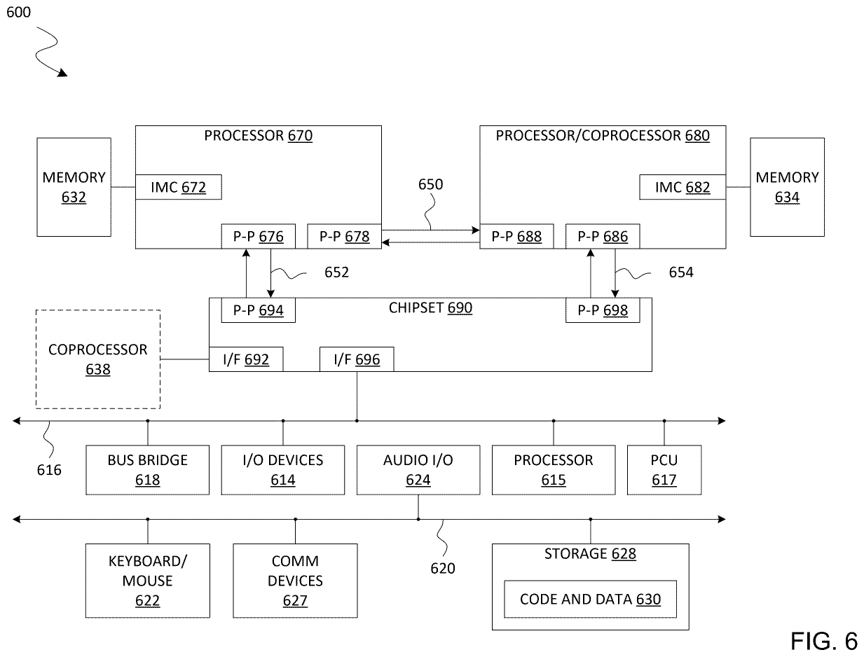

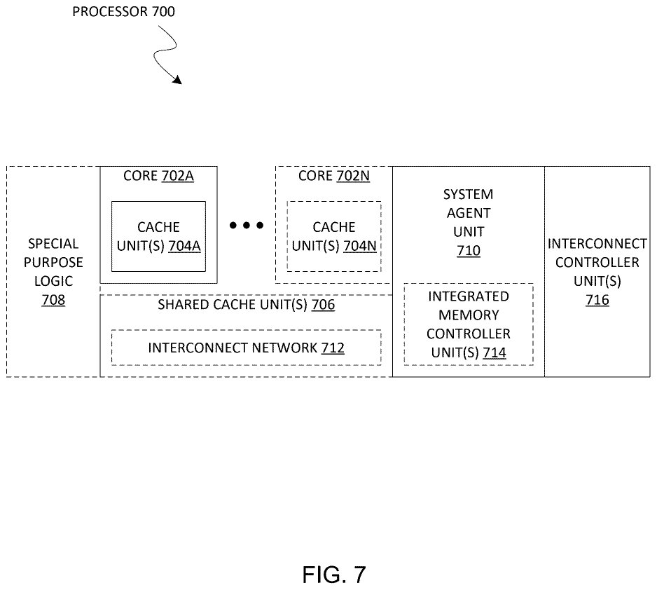

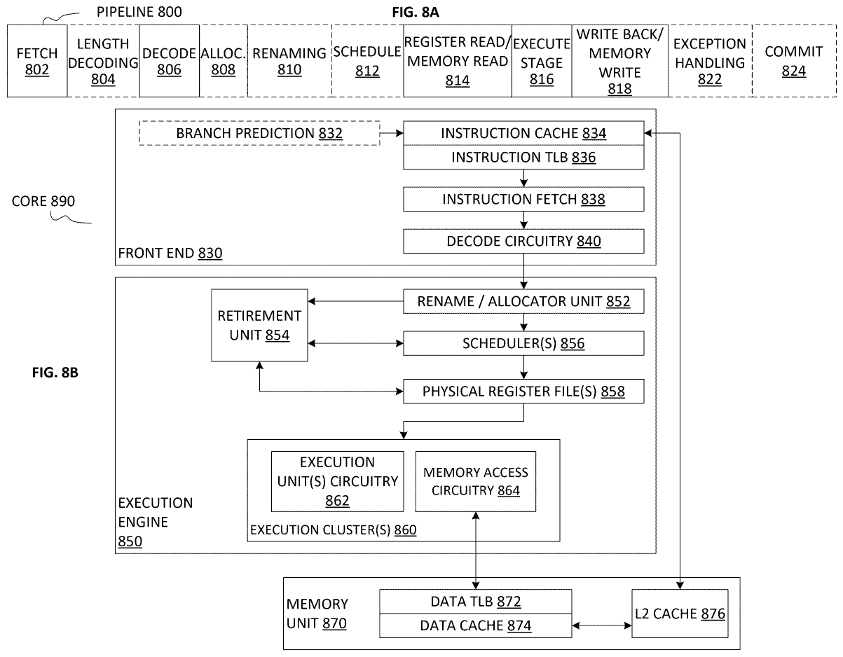

In some embodiments, circuitry of processor 110 is adapted from, and/or is incorporated with, any of various suitable processor architectures. By way of illustration and not limitation, any of various suitable embodiments of processor 110 are implemented, for example, in the processor 670 (FIG. 6), the processor/coprocessor 680 (FIG. 6), the processor 700 (FIG. 7), the pipeline 800 (FIG. 8A), and/or the core 890 (FIG. 8B).

In the example embodiment shown, processor 110 comprises a prefetcher 140 which, for example, is implemented with circuitry and/or micro-architecture of the core 112a. In another embodiment, some or all of prefetcher 140 is implemented with other circuitry of system 100—e.g., including uncore circuitry of processor 110. Note that, while FIG. 1 only shows prefetcher 140 as included in one core 112a, any or all cores 112 include the same or similar prefetch circuitry, in some embodiments.

In some embodiments, prefetcher 140 initiates, manages, and/or executes prefetch requests in the respective core 112a. For example, operation of prefetcher 140 is based on an analysis of memory access requests to determine a data usage pattern in the core 112a. Such a usage pattern provides a basis for predicting data that will be needed by the core 112a in a given time window. Prefetcher 140 then automatically generates a prefetch request for the predicted data. Further, in some embodiments, prefetcher 140 executes the prefetch request to read the predicted data from a repository (e.g., system memory 105, of from a cache of processor 110), and stores the read data in a (different) cache of processor 110. In various embodiments, the generation of a prefetch request with prefetcher 140 includes operations that, for example, are adapted from conventional prefetch techniques (which are not detailed herein to avoid obscuring features of said embodiments).

To facilitate efficient prefetching according to some embodiments, prefetcher 140 includes, is coupled to access, or otherwise operates with, one or more prefetch filters (e.g., including the illustrative filter 142 shown) each of which, when enabled, is to prevent or otherwise limit the generation or servicing of one or more prefetch requests.

In some embodiments, prefetch (re) configurability is provided—e.g., at a slice-specific (or, for example, a corresponding region-specific) level of granularity. By way of illustration and not limitation, prefetcher 140 is operable to selectively enable or disable a prefetch filter which only applies to one slice of an address space (and, for example, only a memory region which is addressable using addresses in said address space). In one such embodiment, prefetcher 140 is operable to selectively enable or disable any of multiple prefetch filters, independent of each other, where each such filter applies to prefetching for a different respective address slice (e.g., where each such filter applies to prefetching to or from a different respective memory region).

In various embodiments, one or more memory regions (e.g., pages) of system 100 each correspond to a different respective prefetch filter, wherein a given one such prefetch filter—when applied—is to prevent or otherwise limit prefetching to and/or from the corresponding memory region. By way of illustration and not limitation, cache(s) 114 comprise one or more regions 115 that, for example, each comprise a respective one or more pages, or a portion of such a page—e.g., wherein each such region comprises a respective plurality of cache lines. In one such embodiment, some or all of region(s) 115 each correspond to a different respective slice of an address space. Alternatively or in addition, cache 116 similarly comprises one or more regions 117 which, for example, each correspond to a different respective slice of an address space.

In an illustrative scenario according to one embodiment, some or all of region(s) 115 and/or some or all of region(s) 117 are dedicated, during operation of processor 110, each to a different respective address slice. By way of illustration and not limitation, region(s) 117 are dedicated each to correspond to a different respective region of system memory 105 (or other such memory coupled to processor 110). Alternatively or in addition, region(s) 115 are dedicated each to correspond to a different respective one of region(s) 117 and/or each to a different respective region of system memory 105. For a given one such cache region, cache lines of the region are to cache only data which is retrieved from—or, alternatively, which is available to be retrieved only to—a memory region which is indicated by a corresponding slice of the address space.

Some embodiments variously provide functionality to evaluate identified opportunities for prefetching information, where the evaluating is to determine which prefetch requests, if any, are to be filtered (e.g., to be prevented from generation, to be rejected, or the like). Such embodiments apply a filter to data which represents the identified opportunities, wherein the filter is determined based on access history information which indicates previous demand memory accesses (if any) and previous prefetch accesses (if any).

For example, system 100 illustrates one embodiment which registers access history information for a given plurality of line of a cache or other suitable memory resource. For each such line, circuitry of processor 110 registers whether the line has previously been targeted—e.g., written to (or, for example, read from)—by a respective demand memory access. Furthermore, such circuitry registers whether the line in question has previously been targeted by a respective prefetch access. In various embodiments, a registry of access history information comprises one or more records which each correspond to (and which each indicate respective previous accesses of) a different respective plurality of lines.

By way of illustration and not limitation, core 112a further comprises an access tracker 120, circuitry of which is coupled to monitor memory accesses based on an execution of an instruction sequence. Access tracker 120 includes, or is otherwise coupled to operate with, a registry 122 of access history information for one or more memory regions—e.g., including some or all of region(s) 115, region(s) 117, one or more regions (not shown) of system memory 105, and/or the like. For example, registry 122 comprises one or more records which each correspond to a different respective plurality of lines of a cache or other suitable memory. In an illustrative scenario according to one embodiment, a first record 124 of registry 122 corresponds to a first plurality of cache lines (e.g., to one or more pages of a cache and, in some embodiments, to an entire cache).

Based on the monitoring of memory accesses, access tracker 120 generates, maintains or otherwise provides a vector—referred to herein as a “completed vector”—which specifies, for each cache line of a given plurality of lines, whether (or not) the line in question has been accessed based on a respective previous prefetch. For example, access tracker 120 comprises circuitry which is operable to detect that a prefetch (actual or expected) is to target a given line of a cache (or other suitable memory resource)—e.g., wherein access tracker 120 is coupled to snoop or otherwise detect an address in a prefetch request. Based on the detected prefetch, access tracker 120 updates a record in registry 122, such as the record 124 which corresponds to the first plurality of lines. For example, access tracker 120 updates a demand vector DAV 125 in record 124, wherein DAV 125 includes bits (or other suitable values) which each identify, for a different respective cache line of the first plurality of cache lines, whether the cache line has been accessed based on a respective demand memory access instruction

Further based on the monitoring of memory accesses, access tracker 120 generates, maintains or otherwise provides a vector (i.e., a set of values)—referred to herein as a “demand vector”—which specifies, for each line of a plurality of cache lines (for example), whether or not the cache line in question has been accessed based on a respective demand memory access instruction. For example, access tracker 120 is further operable to detect that a demand memory access is to target a given line which, for example, is also of the first plurality of cache lines referred to above. Based on the detected demand memory access, access tracker 120 updates a corresponding access history record of registry 122. For example, access tracker 120 updates record 124 to indicate that the line in question has been subject to (that is, targeted by) at least one demand memory access. For example, access tracker 120 updates a completed vector CPV 126 in record 124, wherein CPV 126 includes values which each identify, for a different respective cache line of the first plurality of cache lines, whether the cache line in question has been accessed based on a respective previous prefetch.

Core 112a further comprises circuitry (such as that of the illustrative candidacy detector 130 shown) which is operable to identify one or more opportunities to prefetch data, where the identifying is based on the executing instruction sequence which is monitored by access tracker 120. In an embodiment, candidacy detector 130 is coupled to snoop or otherwise detect executing instructions, and to identify one or more data usage patterns in the core 112a. The one or more data usage patterns provide a basis for candidacy detector 130 to predict the need for other data by the core 112a in a given time window.

For example, candidacy detector 130 successively performs multiple evaluations which are each to generate a respective one or more vectors (referred to herein as “candidate vectors”) during a corresponding evaluation cycle. A given one such candidate vector corresponds to a respective plurality of cache (or other) lines, wherein the candidate vector specifies, for each such line, whether the line is qualified as a candidate to be potentially accessed by a respective future prefetch. By way of illustration and not limitation, candidacy detector 130 generates multiple candidate vectors in a given evaluation cycle—e.g., where some or all such candidate vectors each correspond to the same cache page, and further correspond each to different respective candidacy algorithm. Accordingly, in a given evaluation cycle, a particular cache line is subject to being identified in one candidate vector as being a prefetch candidate according to one candidacy algorithm, while also being identified in a different candidate vector as not being a prefetch candidate according to a different candidacy algorithm.

In an illustrative scenario according to one embodiment, candidacy detector 130 comprise one or more detector units which are to identify respective candidate prefetches each according to a different respective algorithm, other suitable basis (e.g., represented by the illustrative criteria 132 shown). By way of illustration and not limitation, one or more detector units of candidacy detector 130 are to identify respective prefetch candidates each using a different respective one of a stride prefetch algorithm, an access map pattern matching (AMPM) algorithm, a variable length delta prefetching (VLDP) algorithm, a signature path prefetching (SPP) algorithm, a best offset prefetching (BOP) algorithm, or the like.

In an embodiment, candidacy detector 130 provides one or more candidate vectors (such as the illustrative candidate vector 134 shown) to specify or otherwise indicate one or more prefetch candidates to prefetcher 140. In one such embodiment, candidacy detector 130 communicates multiple candidate vectors each for the same cache page (for example)—e.g., wherein prefetcher 140 provides functionality to consolidate the multiple candidate vectors into a single candidate vector (referred to herein as a “consolidated candidate vector” or, for brevity, merely “consolidated vector”). In another embodiment, candidacy detector 130 performs such vector consolidation—e.g., wherein candidate vector 134 includes one or more consolidated candidate vectors each for a different respective plurality of cache lines.

In various embodiments, the generation of a consolidated candidate vector comprises candidacy detector 130, prefetcher 140 or other suitable circuit hardware of core 112a determining multiple “preliminary” candidate vectors which are each based on a different respective prefetch algorithm, and performing a bit-wise OR calculation with the multiple preliminary candidate vectors to calculate the consolidated candidate vector.

In an embodiment, prefetcher 140 receives, calculates or otherwise determines a filter 142 which is to be applied to candidate vector 134 for determining which one or more prefetch requests (if any) are to be generated for a corresponding plurality of cache lines. In one such embodiment, filter 142 includes a vector which is generated based on both a demand vector (such as DAV 125) for the corresponding plurality of cache lines, and a completed vector (such as CPV 126) for the corresponding plurality of cache lines.

In various embodiments, a given candidate prefetch is to be filtered (e.g., according to filter 142) based on whether the cache (or other) line in question has been previously accessed—e.g., at least since a creation of a corresponding record in registry 122. By way of illustration and not limitation, a given candidate prefetch is to be filtered where the cache (or other) line in question has not yet been accessed based on a respective demand memory access instruction, and has also not yet been accessed based on a respective previous prefetch. In one such embodiment, the filtering of prefetch candidates includes or is otherwise based on one or more Boolean operations which are performed with each of a (consolidated) candidate vector, a corresponding demand vector, and a corresponding completed vector.

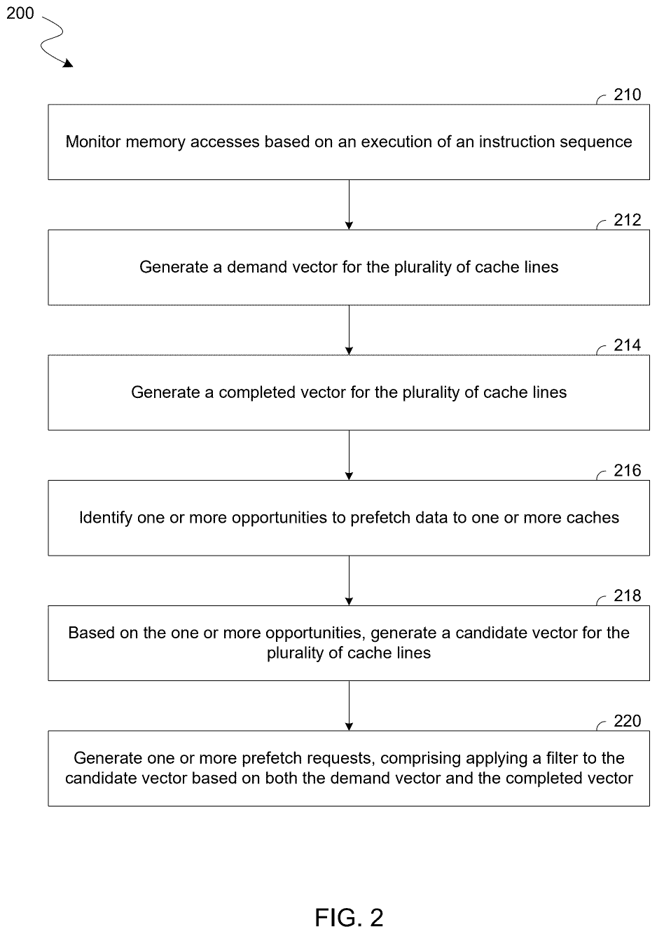

FIG. 2 shows a method 200 for applying a prefetch filter based on a history of previous demand memory accesses and previous prefetches according to an embodiment. The method 200 illustrates one example of an embodiment wherein a prefetch filter, specific to a given region of a memory resource, is selectively applied based on previous demand accesses to that memory resource region, and previous completed prefetch accesses to that memory resource region. Operations such as those of method 200 are performed with any of various combinations of suitable hardware (e.g., circuitry), firmware and/or executing software which, for example, provide some or all of the functionality of processor 110.

As shown in FIG. 2, method 200 comprises (at 210) monitoring memory accesses based on an execution of an instruction sequence at a processor where method 200 is performed. The monitoring at 210 is performed, for example, with access tracker 120 of core 112a. Based on the memory accesses monitored at 210, method 200 (at 212) generates a demand vector (such as demand access vector 125, for example) which specifies, for each cache line of a plurality of cache lines, whether the cache line has been accessed based on a respective demand memory access instruction. Further based on the memory accesses monitored at 210, method 200 (at 214) generates a completed vector (such as completed prefetch vector 126) which specifies, for each cache line of the plurality of cache lines, whether the cache line has been accessed based on a respective previous prefetch.

In some embodiments, method 200 comprises additional operations (not shown) which similarly generate, for each of one or more other pluralities of cache lines, both a respective demand vector and a respective completed vector. In various embodiments, one particular cache of the processor comprises each of the plurality of cache lines—e.g., wherein that same cache or, alternatively, a different cache of the processor comprises each of another such plurality of cache lines.

Method 200 further comprises (at 216) identifying, based on the execution of the instruction sequence, one or more prefetch candidates—i.e., one or more opportunities to prefetch data to one or more caches. In some embodiments, the identifying is according to a single prefetch candidate identification algorithm or, alternatively, is according to multiple prefetch candidate identification algorithms which (for example) are performed sequentially or in parallel with each other.

Based on the one or more prefetch opportunities identified at 216, method 200 (at 218) generates a candidate vector which specifies, for each cache line of the plurality of cache lines, whether the cache line is a candidate to be accessed by a respective previous prefetch. By way of illustration and not limitation, generating the candidate vector at 218 comprises generating multiple preliminary candidate vectors, each based on a different respective prefetch candidate identification algorithm, and combining the multiple preliminary candidate vectors to generate a single consolidated candidate vector. In one such embodiment, generating the single consolidated candidate vector comprises performing a bit-wise OR calculation with each of the multiple preliminary candidate vectors.

Method 200 further comprises (at 220) generating one or more prefetch requests, wherein a filter is applied to the candidate vector, which is generated at 218, based on both the demand vector generated at 212 and the completed vector generated at 214. In one embodiment, a candidate prefetch is to be filtered, according to the filter, where the corresponding cache line has not been accessed based on a respective demand memory access instruction, and has also has not been accessed based on a respective previous prefetch. In some embodiments, method 200 further updates the completed vector, which is generated at 214, to indicate the one or more prefetch requests which are generated at 220.

In various embodiments, method 200 further comprises one or more additional operations—not shown—which generate corresponding vectors (e.g., a corresponding demand vector, a corresponding completed vector, and a corresponding candidate vector), each for a different respective other plurality of cache lines. In one such embodiment, the one or more additional operations are further to selectively apply to one or more filters to various prefetch candidates based on said vectors.

In some embodiments, method 200 further comprises one or more additional operations (not shown) which retain vectors—e.g., including those variously generated at 212, 214 and/or 218—in a backing store for subsequent retrieval, as needed, for (re) evaluation in subsequent prefetch filtering. By way of illustration and not limitation, a candidate vector (e.g., a consolidated candidate vector) is dequeued from a vector queue—e.g., according to a first-in-first-out dequeuing scheme—and provided to the backing store after a prefetch filtering is applied to the candidate vector.

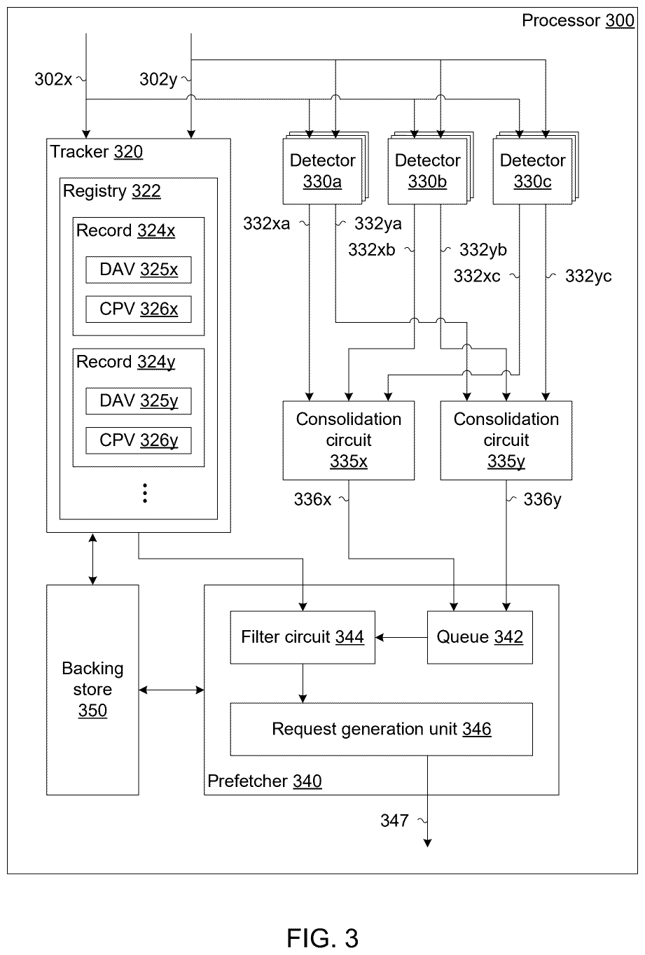

FIG. 3 shows a processor 300 which applies a filter to a vector which represents consolidated prefetch candidates according to an embodiment. Processor 300 illustrates features of one example embodiment wherein prefetch candidates are identified, each according to a respective one of various different algorithms, and then consolidated before being evaluated based on previous demand accesses and previous prefetch accesses each to a corresponding memory region. In some embodiments, processor 300 provides functionality such as that of processor 110—e.g., wherein operations of method 200 are performed with some or all of processor 300.

As shown in FIG. 3, processor 300 comprises a tracker 320 and a prefetcher 340 which, for example, provide functionality of access tracker 120, and prefetcher 140 (respectively). Functionality such as that of candidacy detector 130 is provided, for example, with detectors 330a, 330b, 330c of processor 300—e.g., wherein detectors 330a, 330b, 330c are to variously identify prefetch candidates each according to a different respective candidacy detection algorithm and/or other suitable criteria.

In an embodiment, tracker 320 includes, is coupled to access, or otherwise operates based on a registry 322 of access history information, such as that provided with registry 122 (for example). Registry 322 comprises multiple records which each correspond to a different respective one or more cache pages. In the example embodiment shown, records 324x, 324y correspond to a first one or more cache pages and a second one or more cache pages, respectively—e.g., wherein respective demand access vectors 325x, 325y of records 324x, 324y variously provide functionality such as that of demand access vector 125, and wherein respective completed vector 326x, 326y of records 324x, 324y variously provide functionality such as that of completed prefetch vector 126 (for example). In various alternative scenarios, registry 322 includes more, fewer and/or different access history records.

In an embodiment, tracker 320 is coupled to snoop or otherwise detect a first one or more signals (e.g., including the illustrative signal 302x shown) which specify or otherwise indicate accesses—such as demand memory accesses and/or prefetch accesses—each to a respective line of the first one or more cache pages. Furthermore, tracker 320 is coupled to snoop or otherwise detect a second one or more signals (e.g., including the illustrative signal 302y) which indicate accesses—such as demand memory accesses and/or prefetch accesses—each to a respective line of the second one or more cache pages.

Some or all such signals 302x, 302y are further provided to detectors 330a, 330b, 330c, which variously detect for prefetch candidates according to (respectively) a first candidacy algorithm, a second candidacy algorithm, and a third candidacy algorithm. In some embodiments, detector 330a generates a candidate vector 332xa which corresponds to the first one or more cache pages and to the first candidacy algorithm—e.g., wherein bits of candidate vector 332xa each identify, for a corresponding line of the first one or more cache pages, whether a prefetch candidate has been identified for the line according to the first candidacy algorithm. In one such embodiment, detector 330a further generates a candidate vector 332ya which corresponds to the second one or more cache pages and to the first candidacy algorithm—e.g., wherein bits of candidate vector 332ya each identify, for a corresponding line of the second one or more cache pages, whether a prefetch candidate has been identified for the line according to the first candidacy algorithm.

Detector 330b similarly generates a candidate vector 332xb which corresponds to the first one or more cache pages and to the second candidacy algorithm, and further generates a candidate vector 332yb which corresponds to the second one or more cache pages and to the second candidacy algorithm. Furthermore, detector 330c similarly generates a candidate vector 332xc which corresponds to the first one or more cache pages and to the third candidacy algorithm, and further generates a candidate vector 332yc which corresponds to the second one or more cache pages and to the third candidacy algorithm.

A consolidation circuit 335x of processor 300 is coupled to receive the candidate vectors 332xa, 332xb, 332xc which each correspond to the first one or more cache pages. Based on candidate vectors 332xa, 332xb, 332xc, consolidation circuit 335x generates a consolidated candidate vector 336x which (for example) indicates, for each line of the first one or more cache pages, whether a respective prefetch candidate was identified by at least one of the first, second and third candidacy algorithms. In one example embodiment, generation of consolidated vector 336x comprises consolidation circuit 335x performing a bitwise-OR calculation with each of the candidate vectors 332xa, 332xb, 332xc.

In one such embodiment, another consolidation circuit 335y of processor 300 is coupled to receive the candidate vectors 332ya, 332yb, 332yc which each correspond to the second one or more cache pages. Based on candidate vectors 332ya, 332yb, 332yc, consolidation circuit 335y generates a consolidated candidate vector 336y which (for example) indicates, for each line of the second one or more cache pages, whether a respective prefetch candidate was identified by at least one of the first, second and third candidacy algorithms. In an embodiment, generation of consolidated vector 336y comprises consolidation circuit 335y performing a bitwise-OR calculation with each of the candidate vectors 332ya, 332yb, 332yc.

In various embodiments, prefetcher 340 is coupled to receive one or more (consolidated or other) candidate vectors—e.g., wherein consolidated vectors 336x, 336y are provided to a queue 342 of prefetcher 340. In one such embodiment, prefetcher 340 comprises a filter circuit 344 which is coupled to dequeue a given one such candidate vector from queue 342, and to apply a respective filter to said candidate vector. Filter circuit 344 is further coupled to read or otherwise determine information in an access history record at registry 322, wherein said access history record and the dequeued candidate vector each correspond to the same one or more cache pages. Based on such access history information, filter circuit 344 applies a prefetch filter to the corresponding dequeued candidate vector.

In an illustrative scenario according to one embodiment, filter circuit 344 applies a first filter to consolidated vector 336x based on the DAV 325x and the CPV 326x which, like the consolidated vector 336x, correspond to the first one or more cache pages. In one such embodiment, determining of the first filter includes or is otherwise based on a bitwise-OR calculation with each of the DAV 325x and CPV 326x to generate a first filter vector. Applying the first filter to the consolidated vector 336x includes (for example) filter circuit 344 performing a bitwise-AND calculation with each of the first filter vector and consolidated vector 336x.

Alternatively or in addition, filter circuit 344 applies a second filter to consolidated vector 336y based on the DAV 325y and the CPV 326y which, like the consolidated vector 336y, correspond to the second one or more cache pages. In one such embodiment, determining of the second filter includes or is otherwise based on a bitwise-OR calculation with each of the DAV 325y and CPV 326y to generate a second filter vector. Applying the second filter to the consolidated vector 336y includes (for example) filter circuit 344 performing a bitwise-AND calculation with each of the second filter vector and consolidated vector 336y.

In some embodiments, a request generation unit 346 of prefetcher 340 receives one or more filter vectors from filter circuit 344. Based on the one or more filter vectors, request generation unit 346 generates one or more prefetch requests 347 for prefetch accesses (if any) which have not been filtered with filter circuit 344.

In some embodiments, processor 300 further comprises a backing storage 350 which is coupled to receive candidate vectors from prefetcher 340 and/or to receive demand vectors and/or completed vectors from registry 322. By way of illustration and not limitation, registry 322 is coupled to store some or all of a first candidate vector, a first demand vector, and a first completed vector in association with each other and (for example) in association with a corresponding one or more cache pages. In one such embodiment, candidate vectors are dequeued from queue 342 to backing store 350 (and, for example, to filter circuit 344) according to a first-in-first-out dequeuing scheme—e.g., wherein backing store 350 facilitates the subsequent restoration of one or more candidate vectors to queue 342.

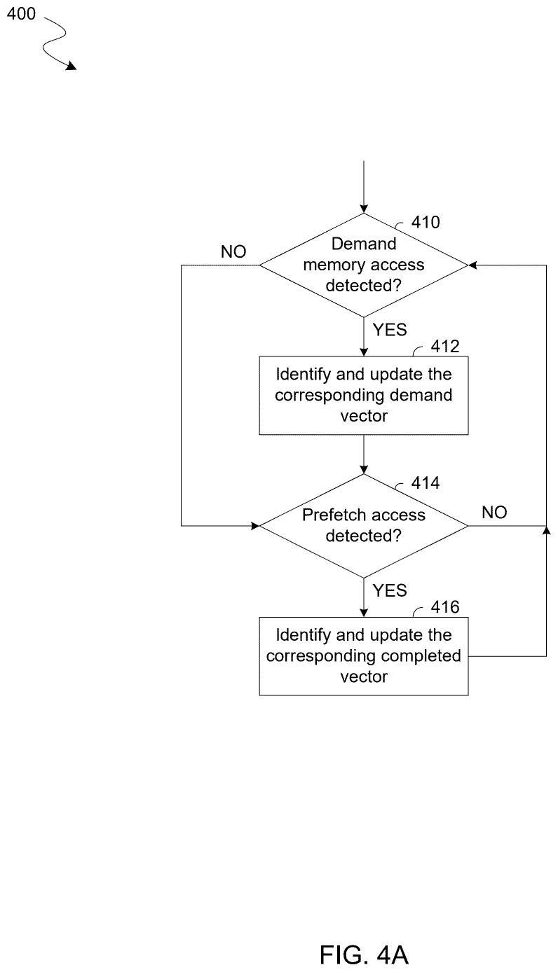

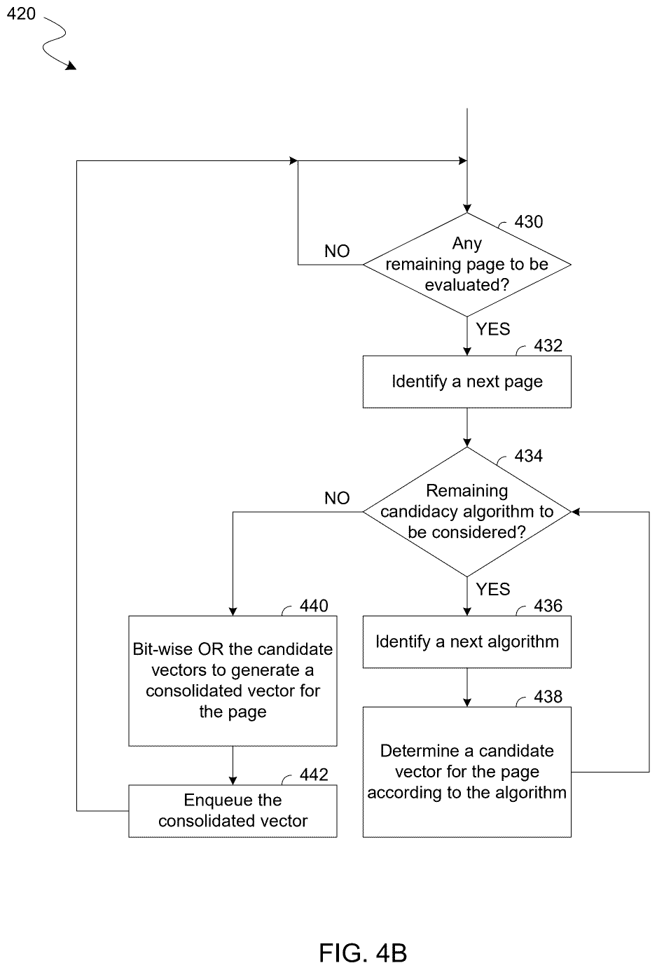

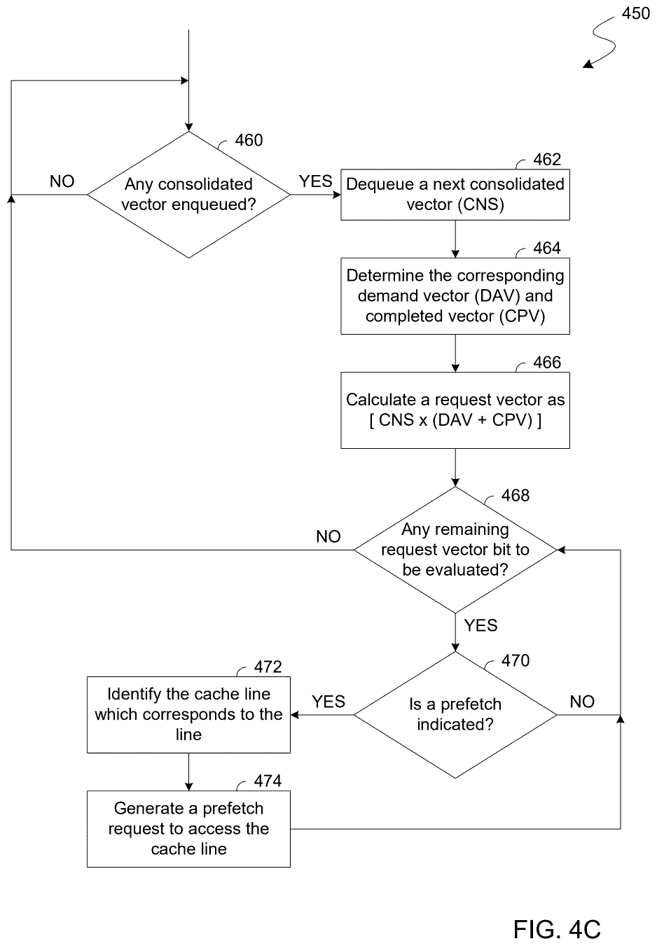

FIG. 4A shows a method 400 for maintaining a record of an access history to facilitate prefetch filtering according to an embodiment. Operations such as those of method 400 are performed with any of various combinations of suitable hardware (e.g., circuitry), firmware and/or executing software which, for example, provide some or all of the functionality of processor 110 or processor 300—e.g., wherein operations of method 200 include or are otherwise based on method 400.

As shown in FIG. 4, method 400 comprises performing an evaluation (at 410) to determine whether a demand memory access is detected. Where such a demand memory access is detected at 410, method 400 (at 412) identifies and updates a demand vector which corresponds to a region (e.g., to a page of a memory and/or a page of a cache) which was subject to that demand memory access. Furthermore, method 400 performs another evaluation (at 414) to determine whether a prefetch access is detected. Where it is instead determined at 410 that no such demand memory access has been detected, method 400 performs the evaluation (at 414) without also performing the identifying and updating at 412.

Where no prefetch access is detected by the evaluating at 414, method 400 performs a next instance of the evaluating at 410. Where it is instead determined at 414 that a prefetch access is detected, method 400 (at 416) identifies and updates a completed prefetch vector which corresponds to a memory region which was subject to the prefetch access most recently detected at 414. After the identifying and updating at 416, method 400 performs a next instance of the evaluating at 410. Accordingly, method 400 maintains a respective demand vector and a respective completed vector for each of one or more regions (e.g., pages) of a cache or memory.

FIG. 4B shows a method 420 for consolidating prefetch candidates which are identified each according to a respective algorithm according to an embodiment. Operations such as those of method 420 are performed with any of various combinations of suitable hardware (e.g., circuitry), firmware and/or executing software which, for example, provide some or all of the functionality of processor 110 or processor 300—e.g., wherein operations of method 200 and/or method 400 include or are otherwise based on method 420.

As shown in FIG. 4, method 420 comprises performing an evaluation (at 430) to determine whether there is any remaining page—or other suitable region of a memory or cache—which is qualified to be evaluated for the identification of prefetch access candidates. Where it is determined at 430 that no such page is currently qualified to be evaluated, method 420 performs a next instance of the evaluating at 430—e.g., until a qualified page is detected. Where it is instead determined at 430 that one or more pages are qualified for prefetch candidacy evaluation, method 420 (at 432) identifies a next page, of the one or more qualified pages, to be so evaluated.

With the page identified at 432, method 420 performs another evaluation (at 434) to determine whether any other prefetch candidacy algorithm remains to be considered for use in identifying possible prefetch access candidates of the page in question. Where it is determined at 434 that some one or more prefetch candidacy algorithms—of a plurality of prefetch candidacy algorithms—remain to be considered in the candidacy evaluations for the page in question, method 420 (at 436) identifies a next one such prefetch candidacy identification algorithm, and (at 438) determines a candidate vector, for the page in question, according to the algorithm most recently identified at 436. After the determining of a candidate vector at 438, method 400 performs a next instance of the evaluating at 434. In some embodiments, method 400 performs respective evaluations—each according to different respective one of the plurality of prefetch candidacy algorithms—in parallel and/or concurrently with one another (e.g., for the same page, or for different respective pages).

Where it is determined at 434 that no such prefetch candidacy algorithm remains to be considered for the page in question, method 420 (at 440) calculates a bit-wise OR of the candidate vectors which have been determined for the page in question—e.g., where the calculation is to generate a consolidated candidate vector for said page. After the calculating at 440, method 420 enqueues the resulting consolidated vector (at 442) for later use in the determining of whether—and if so, which—candidate prefetches are to be subsequently filtered. After the enqueueing at 442, method 420 performs a next instance of the evaluating at 430.

FIG. 4C shows a method 450 for selectively filtering prefetch candidates based on a history of previous demand memory accesses and previous prefetches according to an embodiment. Operations such as those of method 450 are performed with any of various combinations of suitable hardware (e.g., circuitry), firmware and/or executing software which, for example, provide some or all of the functionality of processor 110 or processor 300—e.g., wherein operations of method 200, method 400, and/or method 420 include or are otherwise based on method 450.

As shown in FIG. 4, method 450 comprises performing an evaluation (at 460) to determine whether any consolidated candidate vector is currently available in a queue (e.g., one fed by the enqueueing at 442 of method 420). Where it is determined at 460 that no such consolidated vector is currently enqueued, method 450 performs a next instance of the evaluating at 460—e.g., until an enqueued vector is detected. Where it is instead determined at 460 that such a consolidated vector is enqueued, method 450 (at 462) dequeues a next consolidated vector (CNS) from the queue.

Method 450 further comprises (at 464) determining—e.g., calculating, reading or otherwise accessing—both a demand access vector (DAV) and a completed vector (CPV) which each correspond to the same page to which the dequeued vector CNS corresponds. By way of illustration and not limitation, the vectors DAV, CPV determined at 464 are generated (for example) with operations of method 400.

With the vector CNS most recently dequeued at 462, and with the vectors DAV, CPV most recently determined at 464, method 450 determines a corresponding request vector which indicates any prefetch requests to be generated for the page in question. In the example embodiment shown, such determining comprises (at 466) calculating the corresponding request vector as a Boolean combination of the vectors CNS, DAV, CPV—i.e., wherein vector CNS is bit-wise AND'ed with a binary value which is determined by the vector DAV being bit-wise OR'ed with the vector CPV. In one such embodiment, the request vector indicates that a prefetch request is to be generated, for a given line of the page in question, where the line has been identified as a prefetch candidate, and where the line has previously been subject to a previous prefetch access and/or a previous demand memory access.

With the request vector most recently calculated at 466, method 450 performs an evaluation (at 468) to determine whether any bit of the request vector (i.e., in a respective bit position which corresponds to a line of the page in question) remains to be evaluated. Where it is determined at 468 that all relevant bits of the request vector have been evaluated, method 450 performs a next instance of the evaluating at 460. Where it is instead determined at 468 that that there is still at least one request vector bit to be evaluated, method 450 performs another evaluation (at 470) to determine whether a particular one such remaining request vector bit indicates a prefetch which is to be requested.

Where it is determined at 470 that that the request vector bit in question does indicate such a prefetch, method 450 (at 472) identifies the cache line which corresponds to said bit, and (at 474) generates a prefetch request to access the identified cache line. Where it is instead determined at 470 that that the request vector bit in question does not indicate a prefetch, method 450 performs a next instance of the evaluating at 468.

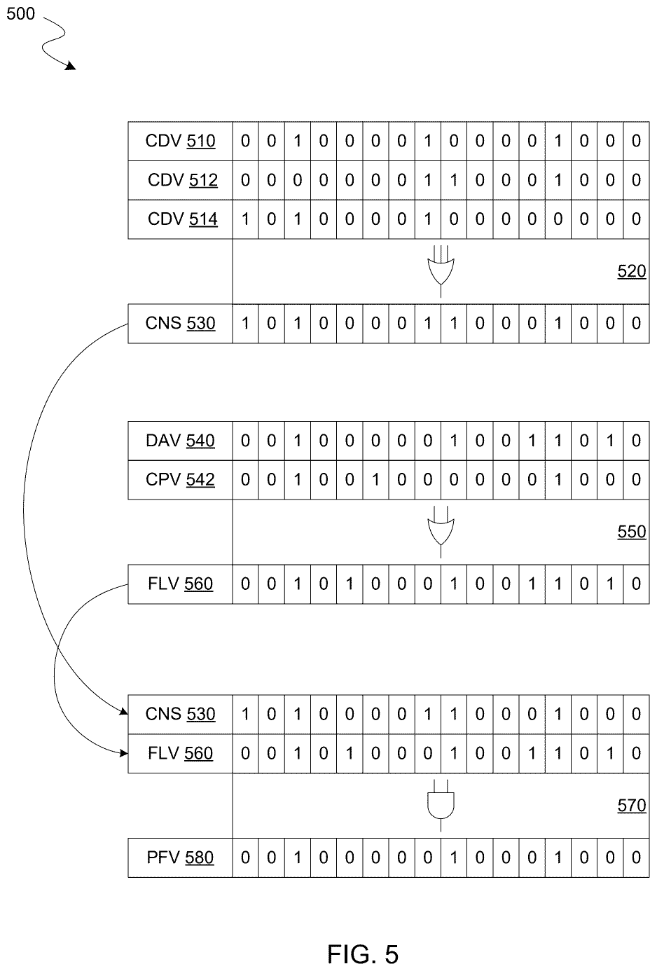

FIG. 5 shows a format of information which is operated on by processing 500 which applies a filter to prefetch candidates according to an embodiment. Functionality such as that illustrated by processing 500 is provided, for example, with processor 110 or processor 300—e.g., wherein processing 500 includes, or is otherwise based on, operations of one of methods 200, 400, 420, 450.

As shown in FIG. 5, processing 500 operates on candidate vectors CDV 510, CDV 512 and CDV 514 which each correspond to a first one or more cache pages—e.g., wherein candidate vectors CDV 510, CDV 512 and CDV 514 provide functionality of candidate vectors 332xa, 332xb, 332xc (respectively). Processing 500 further operates on a demand vector DAV 540 and a completed vector CPV 542 which each correspond to the same first one or more cache pages—e.g., wherein DAV 540 and CPV 542 provide functionality of DAV 325x and CPV 326x (respectively).

By way of illustration and not limitation, processing 500 generates a consolidated candidate vector CNS 530 by performing a bitwise-OR calculation 520 with each of the candidate vectors CDV 510, CDV 512 and CDV 514. In an embodiment, CNS 530 comprises bits which each correspond to a different respective line of the first one or more cache pages, wherein each such bit identifies whether the line in question has been identified, by at least one of multiple different candidacy detection algorithms, as qualifying to be a candidate for a possible future prefetch access.

Furthermore, processing 500 generates a filter vector FLV 560 by performing a bitwise-OR calculation 550 with each of the DAV 540 and CPV 542. In an embodiment, FLV 560 comprises bits which each correspond to a different respective line of the first one or more cache pages, wherein each such bit identifies whether—at least since the creation of a corresponding access history record—the line in question has previously been targeted by at least one of a respective demand memory access or a respective prefetch access.

Further still, processing 500 generates a prefetch request vector PFV 580 by performing a bitwise-AND calculation 570 with each of the consolidated candidate vector CNS 530 and the filter vector FLV 560. In an embodiment, PFV 580 comprises bits which each correspond to a different respective line of the first one or more cache pages, wherein each such bit identifies whether a respective prefetch request is to be generated to access (e.g., read from or write to) the corresponding cache line.

### Exemplary Computer Architectures.

Detailed below are describes of exemplary computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

FIG. 6 illustrates an exemplary system. Multiprocessor system 600 is a point-to-point interconnect system and includes a plurality of processors including a first processor 670 and a second processor 680 coupled via a point-to-point interconnect 650. In some examples, the first processor 670 and the second processor 680 are homogeneous. In some examples, first processor 670 and the second processor 680 are heterogenous. Though the exemplary system 600 is shown to have two processors, the system may have three or more processors, or may be a single processor system.

Processors 670 and 680 are shown including integrated memory controller (IMC) circuitry 672 and 682, respectively. Processor 670 also includes as part of its interconnect controller point-to-point (P-P) interfaces 676 and 678; similarly, second processor 680 includes P-P interfaces 686 and 688. Processors 670, 680 may exchange information via the point-to-point (P-P) interconnect 650 using P-P interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a chipset 690 via individual P-P interconnects 652, 654 using point to point interface circuits 676, 694, 686, 698. Chipset 690 may optionally exchange information with a coprocessor 638 via an interface 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via P-P interconnect, such that either or both processors' local cache information may be stored in the shared cache if a processor is placed into a low power mode.

Chipset 690 may be coupled to a first interconnect 616 via an interface 696. In some examples, first interconnect 616 may be a Peripheral Component Interconnect (PCI) interconnect, or an interconnect such as a PCI Express interconnect or another I/O interconnect. In some examples, one of the interconnects couples to a power control unit (PCU) 617, which may include circuitry, software, and/or firmware to perform power management operations with regard to the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interconnect 616, along with a bus bridge 618 which couples first interconnect 616 to a second interconnect 620. In some examples, one or more additional processor(s) 615, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 616. In some examples, second interconnect 620 may be a low pin count (LPC) interconnect. Various devices may be coupled to second interconnect 620 including, for example, a keyboard and/or mouse 622, communication devices 627 and a storage circuitry 628. Storage circuitry 628 may be one or more non-transitory machine-readable storage media as described below, such as a disk drive or other mass storage device which may include instructions/code and data 630 in some examples. Further, an audio I/O 624 may be coupled to second interconnect 620. Note that other architectures than the point-to-point architecture described above are possible. For example, instead of the point-to-point architecture, a system such as multiprocessor system 600 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

FIG. 7 illustrates a block diagram of an example processor 700 that may have more than one core and an integrated memory controller. The solid lined boxes illustrate a processor 700 with a single core 702A, a system agent unit circuitry 710, a set of one or more interconnect controller unit(s) circuitry 716, while the optional addition of the dashed lined boxes illustrates an alternative processor 700 with multiple cores 702A-N, a set of one or more integrated memory controller unit(s) circuitry 714 in the system agent unit circuitry 710, and special purpose logic 708, as well as a set of one or more interconnect controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702A-N being one or more general purpose cores (e.g., general purpose in-order cores, general purpose out-of-order cores, or a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704A-N within the cores 702A-N, a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples ring-based interconnect network circuitry 712 interconnects the special purpose logic 708 (e.g., integrated graphics logic), the set of shared cache unit(s) circuitry 706, and the system agent unit circuitry 710, alternative examples use any number of well-known techniques for interconnecting such units. In some examples, coherency is maintained between one or more of the shared cache unit(s) circuitry 706 and cores 702A-N.

In some examples, one or more of the cores 702A-N are capable of multi-threading. The system agent unit circuitry 710 includes those components coordinating and operating cores 702A-N. The system agent unit circuitry 710 may include, for example, power control unit (PCU) circuitry and/or display unit circuitry (not shown). The PCU may be or may include logic and components needed for regulating the power state of the cores 702A-N and/or the special purpose logic 708 (e.g., integrated graphics logic). The display unit circuitry is for driving one or more externally connected displays.

The cores 702A-N may be homogenous in terms of instruction set architecture (ISA). Alternatively, the cores 702A-N may be heterogeneous in terms of ISA; that is, a subset of the cores 702A-N may be capable of executing an ISA, while other cores may be capable of executing only a subset of that ISA or another ISA.

### Exemplary Core Architectures-In-Order and Out-of-Order Core Block Diagram.

FIG. 8A is a block diagram illustrating both an exemplary in-order pipeline and an exemplary register renaming, out-of-order issue/execution pipeline according to examples. FIG. 8B is a block diagram illustrating both an exemplary example of an in-order architecture core and an exemplary register renaming, out-of-order issue/execution architecture core to be included in a processor according to examples. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 8B may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8B shows a processor core 890 including front-end unit circuitry 830 coupled to an execution engine unit circuitry 850, and both are coupled to a memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit circuitry 830 may include branch prediction circuitry 832 coupled to an instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various different mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to a retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, arithmetic generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to a data cache circuitry 874 coupled to a level 2 (L2) cache circuitry 876. In one exemplary example, the memory access circuitry 864 may include a load unit circuitry, a store address unit circuit, and a store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, a level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Exemplary Execution Unit(s) Circuitry.

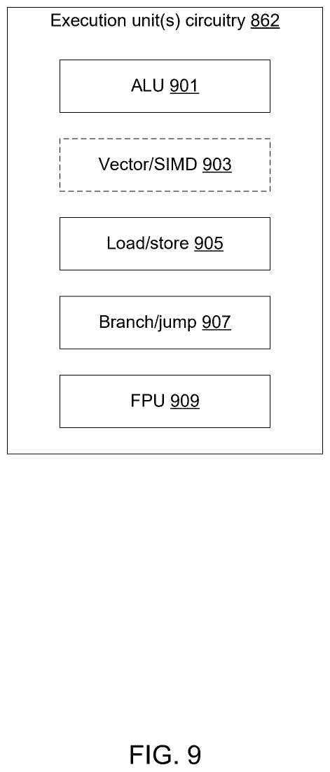

FIG. 9 illustrates examples of execution unit(s) circuitry, such as execution unit(s) circuitry 862 of FIG. 8B. As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

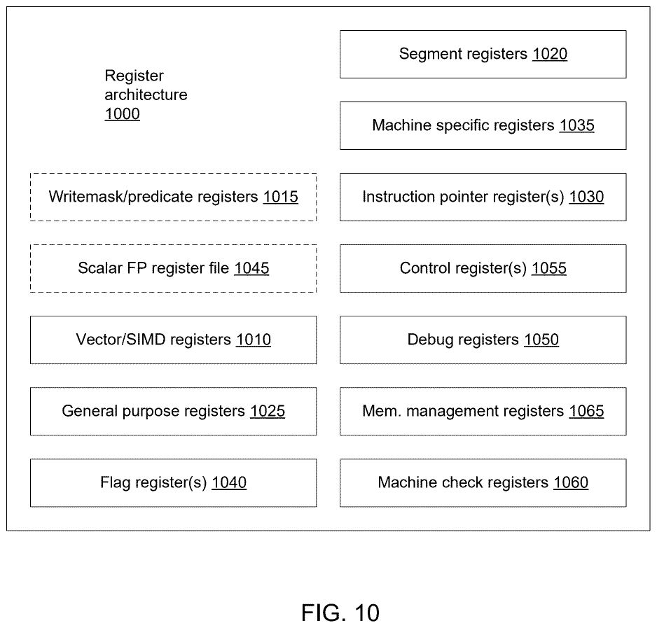

FIG. 10 is a block diagram of a register architecture 1000 according to some examples. As illustrated, the register architecture 1000 includes vector/SIMD registers 1010 that vary from 128-bit to 1,024 bits width. In some examples, the vector/SIMD registers 1010 are physically 512-bits and, depending upon the mapping, only some of the lower bits are used. For example, in some examples, the vector/SIMD registers 1010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1000 includes writemask/predicate registers 1015. For example, in some examples, there are 8 writemask/predicate registers (sometimes called k0 through k7) that are each 16-bit, 32-bit, 64-bit, or 128-bit in size. Writemask/predicate registers 1015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1015 corresponds to a data element position of the destination. In other examples, the writemask/predicate registers 1015 are scalable and consists of a set number of enable bits for a given vector element (e.g., 8 enable bits per 64-bit vector element).

The register architecture 1000 includes a plurality of general-purpose registers 1025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1000 includes scalar floating-point (FP) register 1045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1040 (e.g., EFLAGS, RFLAGS, etc.) store status and control information for arithmetic, compare, and system operations. For example, the one or more flag registers 1040 may store condition code information such as carry, parity, auxiliary carry, zero, sign, and overflow. In some examples, the one or more flag registers 1040 are called program status and control registers.

Segment registers 1020 contain segment points for use in accessing memory. In some examples, these registers are referenced by the names CS, DS, SS, ES, FS, and GS.

Machine specific registers (MSRs) 1035 control and report on processor performance. Most MSRs 1035 handle system-related functions and are not accessible to an application program. Machine check registers 1060 consist of control, status, and error reporting MSRs that are used to detect and report on hardware errors.

One or more instruction pointer register(s) 1030 store an instruction pointer value. Control register(s) 1055 (e.g., CR0-CR4) determine the operating mode of a processor (e.g., processor 670, 680, 638, 615, and/or 700) and the characteristics of a currently executing task. Debug registers 1050 control and allow for the monitoring of a processor or core's debugging operations.

Memory (mem) management registers 1065 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1000 may, for example, be used in physical register file(s) circuitry 858.

Techniques and architectures for filtering prefetches with a processor are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMS, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

In one or more first embodiments, an integrated circuit (IC) comprises first circuitry to monitor memory accesses based on an execution of an instruction sequence, wherein based on the memory accesses, the first circuitry is further to generate a demand vector which specifies, for each cache line of a plurality of cache lines, whether the cache line has been accessed based on a respective demand memory access instruction, and generate a completed vector which specifies, for each cache line of the plurality of cache lines, whether the cache line has been accessed based on a respective previous prefetch, second circuitry, coupled to the first circuitry, to identify, based on the execution of the instruction sequence, one or more opportunities to prefetch data to one or more caches, third circuitry coupled to the second circuitry, wherein based on the one or more opportunities, the third circuitry is to generate a candidate vector which specifies, for each cache line of the plurality of cache lines, whether the cache line is a candidate to be accessed by a respective previous prefetch, and fourth circuitry coupled to the third circuitry, the fourth circuitry to generate one or more prefetch requests, comprising the fourth circuitry to apply a filter to the candidate vector based on both the demand vector and the completed vector.

In one or more second embodiments, further to the first embodiment, a page of a cache comprises the plurality of cache lines, and for each page of multiple pages of the cache the first circuitry is to generate a respective demand vector which specifies, for each cache line of the page, whether the cache line has been accessed based on a respective demand memory access instruction, the first circuitry is to generate a respective completed vector which specifies, for each cache line of the page, whether the cache line has been accessed based on a respective previous prefetch, the third circuitry is to generate a respective candidate vector which specifies, for each cache line of the page, whether the cache line is a candidate to be accessed by a respective previous prefetch, and the fourth circuitry is to generate a respective one or more prefetch requests, comprising the fourth circuitry to apply the filter to the respective candidate vector based on both the respective demand vector and the respective completed vector.

In one or more third embodiments, further to the first embodiment or the second embodiment, the third circuitry to generate the candidate vector comprises the third circuitry to generate multiple preliminary candidate vectors each based on a different respective prefetch algorithm, and perform a bit-wise OR calculation with the multiple preliminary candidate vectors to determine the candidate vector.

In one or more fourth embodiments, further to any of the first through third embodiments, a cache of a processor core comprises the plurality of cache lines, and according to the filter, the fourth circuitry is to filter a candidate prefetch where the corresponding cache line has not been accessed based on a respective demand memory access instruction, and the corresponding cache line has not been accessed based on a respective previous prefetch.

In one or more fifth embodiments, further to any of the first through fourth embodiments, the demand vector, the completed vector, and the plurality of cache lines are, respectively, a first demand vector, a first completed vector, and a first plurality of cache lines, a first cache of a processor comprises the first plurality of cache lines, wherein multiple cores of the processor share the first cache, a core of the multiple cores comprises a second cache, based on the memory accesses the first circuitry is to generate a second demand vector which specifies, for each cache line of a second plurality of cache lines of the second cache, whether the cache line has been accessed based on a respective demand memory access instruction, and the first circuitry is to generate a second completed vector which specifies, for each cache line of the second plurality of cache lines, whether the cache line has been accessed based on a respective previous prefetch, and the fourth circuitry to generate the one or more prefetch requests comprises the fourth circuitry to apply the filter to the candidate vector further based on both the second demand vector and the second completed vector.

In one or more sixth embodiments, further to the fifth embodiment, according to the filter, a candidate prefetch is to be filtered where a corresponding cache line has not been accessed based on a respective demand memory access instruction, and the corresponding cache line has not been accessed based on a respective previous prefetch.

In one or more seventh embodiments, further to any of the first through fourth embodiments, the IC further comprises fourth circuitry to move the candidate vector from a vector queue to a backing storage, wherein the first circuitry is further to provide each of the demand vector and the completed vector to the backing storage, wherein the demand vector, the completed vector, and the candidate vector are associated with each other at the backing storage based on an identifier of the plurality of cache lines.

In one or more eighth embodiments, further to the seventh embodiment, the fourth circuitry is to move the candidate vector from the vector queue according to a first-in-first-out dequeuing scheme.

In one or more ninth embodiments, further to the seventh embodiment, the fourth circuitry is further to restore the candidate vector from the backing storage to the vector queue.

In one or more tenth embodiments, further to any of the first through fourth embodiments, the first circuitry is further to update the completed vector based on the one or more prefetch requests.

In one or more eleventh embodiments, a method comprises monitoring memory accesses based on an execution of an instruction sequence, based on the memory accesses generating a demand vector which specifies, for each cache line of a plurality of cache lines, whether the cache line has been accessed based on a respective demand memory access instruction, and generating a completed vector which specifies, for each cache line of the plurality of cache lines, whether the cache line has been accessed based on a respective previous prefetch, identifying, based on the execution of the instruction sequence, one or more opportunities to prefetch data to one or more caches, based on the one or more opportunities, generating a candidate vector which specifies, for each cache line of the plurality of cache lines, whether the cache line is a candidate to be accessed by a respective previous prefetch, and generating one or more prefetch requests, comprising applying a filter to the candidate vector based on both the demand vector and the completed vector.

In one or more twelfth embodiments, further to the eleventh embodiment, a page of a cache comprises the plurality of cache lines, and the method further comprises for each page of multiple pages of the cache generating a respective demand vector which specifies, for each cache line of the page, whether the cache line has been accessed based on a respective demand memory access instruction, generating a respective completed vector which specifies, for each cache line of the page, whether the cache line has been accessed based on a respective previous prefetch, generating a respective candidate vector which specifies, for each cache line of the page, whether the cache line is a candidate to be accessed by a respective previous prefetch, and generating a respective one or more prefetch requests, comprising applying the filter to the respective candidate vector based on both the respective demand vector and the respective completed vector.

In one or more thirteenth embodiments, further to the eleventh embodiment or the twelfth embodiment, generating the candidate vector comprises generating multiple preliminary candidate vectors each based on a different respective prefetch algorithm, and performing a bit-wise OR calculation with the multiple preliminary candidate vectors to determine the candidate vector.

In one or more fourteenth embodiments, further to any of the eleventh through thirteenth embodiments, a cache of a processor core comprises the plurality of cache lines, and according to the filter, a candidate prefetch is to be filtered where the corresponding cache line has not been accessed based on a respective demand memory access instruction, and the corresponding cache line has not been accessed based on a respective previous prefetch.

In one or more fifteenth embodiments, further to any of the eleventh through fourteenth embodiments, the demand vector, the completed vector, and the plurality of cache lines are, respectively, a first demand vector, a first completed vector, and a first plurality of cache lines, a first cache of a processor comprises the first plurality of cache lines, wherein multiple cores of the processor share the first cache, a core of the multiple cores comprises a second cache, the method further comprises based on the memory accesses generating a second demand vector which specifies, for each cache line of a second plurality of cache lines of the second cache, whether the cache line has been accessed based on a respective demand memory access instruction, and generating a second completed vector which specifies, for each cache line of the second plurality of cache lines, whether the cache line has been accessed based on a respective previous prefetch, and wherein generating the one or more prefetch requests comprises applying the filter to the candidate vector further based on both the second demand vector and the second completed vector.

In one or more sixteenth embodiments, further to the fifteenth embodiment, according to the filter, a candidate prefetch is to be filtered where a corresponding cache line has not been accessed based on a respective demand memory access instruction, and the corresponding cache line has not been accessed based on a respective previous prefetch.

In one or more seventeenth embodiments, further to any of the eleventh through fourteenth embodiments, the method further comprises moving the candidate vector from a vector queue to a backing storage, and providing each of the demand vector and the completed vector to the backing storage, wherein the demand vector, the completed vector, and the candidate vector are associated with each other at the backing storage based on an identifier of the plurality of cache lines.

In one or more eighteenth embodiments, further to the seventeenth embodiment, the candidate vector is moved from the vector queue according to a first-in-first-out dequeuing scheme.

In one or more nineteenth embodiments, further to the seventeenth embodiment, the method further comprises restoring the candidate vector from the backing storage to the vector queue.

In one or more twentieth embodiments, further to any of the eleventh through fourteenth embodiments, the method further comprises updating the completed vector based on the one or more prefetch requests.

In one or more twenty-first embodiments, a system comprises a memory, a memory controller, and a processor coupled to the memory via the memory controller, the processor comprising first circuitry to monitor memory accesses based on an execution of an instruction sequence, wherein based on the memory accesses, the first circuitry is further to generate a demand vector which specifies, for each cache line of a plurality of cache lines, whether the cache line has been accessed based on a respective demand memory access instruction, and generate a completed vector which specifies, for each cache line of the plurality of cache lines, whether the cache line has been accessed based on a respective previous prefetch, second circuitry, coupled to the first circuitry, to identify, based on the execution of the instruction sequence, one or more opportunities to prefetch data to one or more caches, third circuitry coupled to the second circuitry, wherein based on the one or more opportunities, the third circuitry is to generate a candidate vector which specifies, for each cache line of the plurality of cache lines, whether the cache line is a candidate to be accessed by a respective previous prefetch, and fourth circuitry coupled to the third circuitry, the fourth circuitry to generate one or more prefetch requests, comprising the fourth circuitry to apply a filter to the candidate vector based on both the demand vector and the completed vector.

In one or more twenty-second embodiments, further to the twenty-first embodiment, a page of a cache comprises the plurality of cache lines, and for each page of multiple pages of the cache the first circuitry is to generate a respective demand vector which specifies, for each cache line of the page, whether the cache line has been accessed based on a respective demand memory access instruction, the first circuitry is to generate a respective completed vector which specifies, for each cache line of the page, whether the cache line has been accessed based on a respective previous prefetch, the third circuitry is to generate a respective candidate vector which specifics, for each cache line of the page, whether the cache line is a candidate to be accessed by a respective previous prefetch, and the fourth circuitry is to generate a respective one or more prefetch requests, comprising the fourth circuitry to apply the filter to the respective candidate vector based on both the respective demand vector and the respective completed vector.

In one or more twenty-third embodiments, further to the twenty-first embodiment or the twenty-second embodiment, the third circuitry to generate the candidate vector comprises the third circuitry to generate multiple preliminary candidate vectors each based on a different respective prefetch algorithm, and perform a bit-wise OR calculation with the multiple preliminary candidate vectors to determine the candidate vector.

In one or more twenty-fourth embodiments, further to any of the twenty-first through twenty-third embodiments, a cache of a processor core comprises the plurality of cache lines, and according to the filter, the fourth circuitry is to filter a candidate prefetch where the corresponding cache line has not been accessed based on a respective demand memory access instruction, and the corresponding cache line has not been accessed based on a respective previous prefetch.

In one or more twenty-fifth embodiments, further to any of the twenty-first through twenty-fourth embodiments, the demand vector, the completed vector, and the plurality of cache lines are, respectively, a first demand vector, a first completed vector, and a first plurality of cache lines, a first cache of the processor comprises the first plurality of cache lines, wherein multiple cores of the processor share the first cache, a core of the multiple cores comprises a second cache, based on the memory accesses the first circuitry is to generate a second demand vector which specifies, for each cache line of a second plurality of cache lines of the second cache, whether the cache line has been accessed based on a respective demand memory access instruction, and the first circuitry is to generate a second completed vector which specifies, for each cache line of the second plurality of cache lines, whether the cache line has been accessed based on a respective previous prefetch, and the fourth circuitry to generate the one or more prefetch requests comprises the fourth circuitry to apply the filter to the candidate vector further based on both the second demand vector and the second completed vector.

In one or more twenty-sixth embodiments, further to the twenty-fifth embodiment, according to the filter, a candidate prefetch is to be filtered where a corresponding cache line has not been accessed based on a respective demand memory access instruction, and the corresponding cache line has not been accessed based on a respective previous prefetch.

In one or more twenty-seventh embodiments, further to any of the twenty-first through twenty-fourth embodiments, the processor further comprises fourth circuitry to move the candidate vector from a vector queue to a backing storage, wherein the first circuitry is further to provide each of the demand vector and the completed vector to the backing storage, wherein the demand vector, the completed vector, and the candidate vector are associated with each other at the backing storage based on an identifier of the plurality of cache lines.

In one or more twenty-eighth embodiments, further to the twenty-seventh embodiment, the fourth circuitry is to move the candidate vector from the vector queue according to a first-in-first-out dequeuing scheme.

In one or more twenty-ninth embodiments, further to the twenty-seventh embodiment, the fourth circuitry is further to restore the candidate vector from the backing storage to the vector queue.

In one or more thirtieth embodiments, further to any of the twenty-first through twenty-fourth embodiments, the first circuitry is further to update the completed vector based on the one or more prefetch requests.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit (IC) comprising:
first circuitry to monitor memory accesses based on an execution of an instruction sequence, wherein based on the memory accesses, the first circuitry is further to:
generate a demand vector which specifies, for each cache line of a plurality of cache lines, whether the cache line has been accessed based on a respective demand memory access instruction; and
generate a completed vector which specifies, for each cache line of the plurality of cache lines, whether the cache line has been accessed based on a respective previous prefetch;
second circuitry, coupled to the first circuitry, to identify, based on the execution of the instruction sequence, one or more opportunities to prefetch data to one or more caches;
third circuitry coupled to the second circuitry, wherein based on the one or more opportunities, the third circuitry is to generate a candidate vector which specifies, for each cache line of the plurality of cache lines, whether the cache line is a candidate to be accessed by a respective previous prefetch; and
fourth circuitry coupled to the third circuitry, the fourth circuitry to generate one or more prefetch requests, comprising the fourth circuitry to apply a filter to the candidate vector based on both the demand vector and the completed vector.

2. The IC of claim 1, wherein:
a page of a cache comprises the plurality of cache lines; and
for each page of multiple pages of the cache:
the first circuitry is to generate a respective demand vector which specifies, for each cache line of the page, whether the cache line has been accessed based on a respective demand memory access instruction;
the first circuitry is to generate a respective completed vector which specifies, for each cache line of the page, whether the cache line has been accessed based on a respective previous prefetch;
the third circuitry is to generate a respective candidate vector which specifies, for each cache line of the page, whether the cache line is a candidate to be accessed by a respective previous prefetch; and
the fourth circuitry is to generate a respective one or more prefetch requests, comprising the fourth circuitry to apply the filter to the respective candidate vector based on both the respective demand vector and the respective completed vector.

3. The IC of claim 1, wherein the third circuitry to generate the candidate vector comprises the third circuitry to:
generate multiple preliminary candidate vectors each based on a different respective prefetch algorithm; and
perform a bit-wise OR calculation with the multiple preliminary candidate vectors to determine the candidate vector.

4. The IC of claim 1, wherein:
a cache of a processor core comprises the plurality of cache lines; and
according to the filter, the fourth circuitry is to filter a candidate prefetch where:
the corresponding cache line has not been accessed based on a respective demand memory access instruction; and
the corresponding cache line has not been accessed based on a respective previous prefetch.

5. The IC of claim 1, wherein:
the demand vector, the completed vector, and the plurality of cache lines are, respectively, a first demand vector, a first completed vector, and a first plurality of cache lines;
a first cache of the processor comprises the first plurality of cache lines, wherein multiple cores of the processor share the first cache;
a core of the multiple cores comprises a second cache;
based on the memory accesses:
the first circuitry is to generate a second demand vector which specifies, for each cache line of a second plurality of cache lines of the second cache, whether the cache line has been accessed based on a respective demand memory access instruction; and
the first circuitry is to generate a second completed vector which specifies, for each cache line of the second plurality of cache lines, whether the cache line has been accessed based on a respective previous prefetch; and
the fourth circuitry to generate the one or more prefetch requests comprises the fourth circuitry to apply the filter to the candidate vector further based on both the second demand vector and the second completed vector.

6. The IC of claim 5, wherein:
according to the filter, a candidate prefetch is to be filtered where:
a corresponding cache line has not been accessed based on a respective demand memory access instruction; and
the corresponding cache line has not been accessed based on a respective previous prefetch.

7. The IC of claim 1, further comprising:
fourth circuitry to move the candidate vector from a vector queue to a backing storage;
wherein the first circuitry is further to provide each of the demand vector and the completed vector to the backing storage, wherein the demand vector, the completed vector, and the candidate vector are associated with each other at the backing storage based on an identifier of the plurality of cache lines.

8. The IC of claim 7, wherein the fourth circuitry is to move the candidate vector from the vector queue according to a first-in-first-out dequeuing scheme.

9. The IC of claim 7, wherein the fourth circuitry is further to restore the candidate vector from the backing storage to the vector queue.

10. The IC of claim 1, wherein the first circuitry is further to update the completed vector based on the one or more prefetch requests.

11. A method comprising:
monitoring memory accesses based on an execution of an instruction sequence;
based on the memory accesses:
generating a demand vector which specifies, for each cache line of a plurality of cache lines, whether the cache line has been accessed based on a respective demand memory access instruction; and
generating a completed vector which specifies, for each cache line of the plurality of cache lines, whether the cache line has been accessed based on a respective previous prefetch;
identifying, based on the execution of the instruction sequence, one or more opportunities to prefetch data to one or more caches;
based on the one or more opportunities, generating a candidate vector which specifies, for each cache line of the plurality of cache lines, whether the cache line is a candidate to be accessed by a respective previous prefetch; and
generating one or more prefetch requests, comprising applying a filter to the candidate vector based on both the demand vector and the completed vector.

12. The method of claim 11, wherein:
a page of a cache comprises the plurality of cache lines; and
the method further comprises:
for each page of multiple pages of the cache:
generating a respective demand vector which specifies, for each cache line of the page, whether the cache line has been accessed based on a respective demand memory access instruction;
generating a respective completed vector which specifies, for each cache line of the page, whether the cache line has been accessed based on a respective previous prefetch;
generating a respective candidate vector which specifies, for each cache line of the page, whether the cache line is a candidate to be accessed by a respective previous prefetch; and
generating a respective one or more prefetch requests, comprising applying the filter to the respective candidate vector based on both the respective demand vector and the respective completed vector.

13. The method of claim 11, wherein generating the candidate vector comprises:
generating multiple preliminary candidate vectors each based on a different respective prefetch algorithm; and
performing a bit-wise OR calculation with the multiple preliminary candidate vectors to determine the candidate vector.

14. The method of claim 11, wherein:
a cache of a processor core comprises the plurality of cache lines; and
according to the filter, a candidate prefetch is to be filtered where:
the corresponding cache line has not been accessed based on a respective demand memory access instruction; and
the corresponding cache line has not been accessed based on a respective previous prefetch.

15. The method of claim 11, wherein:
the demand vector, the completed vector, and the plurality of cache lines are, respectively, a first demand vector, a first completed vector, and a first plurality of cache lines;
a first cache of the processor comprises the first plurality of cache lines, wherein multiple cores of the processor share the first cache;
a core of the multiple cores comprises a second cache;
the method further comprises:
based on the memory accesses:
generating a second demand vector which specifies, for each cache line of a second plurality of cache lines of the second cache, whether the cache line has been accessed based on a respective demand memory access instruction; and
generating a second completed vector which specifies, for each cache line of the second plurality of cache lines, whether the cache line has been accessed based on a respective previous prefetch; and
wherein generating the one or more prefetch requests comprises applying the filter to the candidate vector further based on both the second demand vector and the second completed vector.

16. A system comprising:
a memory;
a memory controller; and
a processor coupled to the memory via the memory controller, the processor comprising:
first circuitry to monitor memory accesses based on an execution of an instruction sequence, wherein based on the memory accesses, the first circuitry is further to:
generate a demand vector which specifies, for each cache line of a plurality of cache lines, whether the cache line has been accessed based on a respective demand memory access instruction; and
generate a completed vector which specifies, for each cache line of the plurality of cache lines, whether the cache line has been accessed based on a respective previous prefetch;
second circuitry, coupled to the first circuitry, to identify, based on the execution of the instruction sequence, one or more opportunities to prefetch data to one or more caches;
third circuitry coupled to the second circuitry, wherein based on the one or more opportunities, the third circuitry is to generate a candidate vector which specifies, for each cache line of the plurality of cache lines, whether the cache line is a candidate to be accessed by a respective previous prefetch; and
fourth circuitry coupled to the third circuitry, the fourth circuitry to generate one or more prefetch requests, comprising the fourth circuitry to apply a filter to the candidate vector based on both the demand vector and the completed vector.

17. The system of claim 16, wherein:
a page of a cache comprises the plurality of cache lines; and
for each page of multiple pages of the cache:
the first circuitry is to generate a respective demand vector which specifies, for each cache line of the page, whether the cache line has been accessed based on a respective demand memory access instruction;
the first circuitry is to generate a respective completed vector which specifies, for each cache line of the page, whether the cache line has been accessed based on a respective previous prefetch;
the third circuitry is to generate a respective candidate vector which specifies, for each cache line of the page, whether the cache line is a candidate to be accessed by a respective previous prefetch; and
the fourth circuitry is to generate a respective one or more prefetch requests, comprising the fourth circuitry to apply the filter to the respective candidate vector based on both the respective demand vector and the respective completed vector.

18. The system of claim 16, wherein the third circuitry to generate the candidate vector comprises the third circuitry to:
generate multiple preliminary candidate vectors each based on a different respective prefetch algorithm; and
perform a bit-wise OR calculation with the multiple preliminary candidate vectors to determine the candidate vector.

19. The system of claim 16, wherein:
a cache of a processor core comprises the plurality of cache lines; and
according to the filter, the fourth circuitry is to filter a candidate prefetch where:
the corresponding cache line has not been accessed based on a respective demand memory access instruction; and
the corresponding cache line has not been accessed based on a respective previous prefetch.

20. The system of claim 16, wherein:
the demand vector, the completed vector, and the plurality of cache lines are, respectively, a first demand vector, a first completed vector, and a first plurality of cache lines;
a first cache of the processor comprises the first plurality of cache lines, wherein multiple cores of the processor share the first cache;
a core of the multiple cores comprises a second cache;
based on the memory accesses:
the first circuitry is to generate a second demand vector which specifies, for each cache line of a second plurality of cache lines of the second cache, whether the cache line has been accessed based on a respective demand memory access instruction; and
the first circuitry is to generate a second completed vector which specifies, for each cache line of the second plurality of cache lines, whether the cache line has been accessed based on a respective previous prefetch; and
the fourth circuitry to generate the one or more prefetch requests comprises the fourth circuitry to apply the filter to the candidate vector further based on both the second demand vector and the second completed vector.
